(19) United States
(12) Patent Application Publication
(10) Pub. No.: US 2018/0157795 A1
(43) Pub. Date: Jun. 7, 2018

(54) MULTILEVEL OBJECT FILE STORAGE

(71) Applicant: International Business Machines Corporation, Armonk, NY (US)

(72) Inventors: Ryan G. DeJana, Longmont, CO (US); Franz F. Liebinger, Heredia (CR); Edgar A. Zamora Duran, Heredia (CR)

(21) Appl. No.: 15/366,721

(22) Filed: Dec. 1, 2016

(51) Int. Cl. G06F 19/00; G06Q 10/00

(52) U.S. Cl. CPC G06F 19/322; G06Q 10/20

(57) ABSTRACT

A message requesting a transfer of management responsibilities for a digital object, representing an asset, from a first digital object management system to a second digital object management system can be received from the first digital object management system. Responsive to receiving the message requesting the transfer of the management responsibilities for the digital object, the digital object can be received from the first digital object management system, at least one operation updating data contained within the digital object can be performed by executing at least a first application contained within the digital object, and the digital object can be communicated to the second digital object management system for storage in a digital object database.

### BACKGROUND

The present invention relates to data processing, and more specifically, to data storage.

In some countries, such as the Unites States, certificates of title are associated with vehicles. A certificate of title is a legal form that establishes a person or organization as the legal owner of a vehicle. In the Unites States, vehicle titles commonly are issued by individual states in which cars are purchased. For the associated vehicle, the vehicle title typically specifies a vehicle identification number, a make, a year of manufacture, a license plate number, and technical information about the vehicle. The vehicle title also typically specifies the name and address of the registered owner and, if money is owed on the vehicle, the lienholder to whom money is owed.

### SUMMARY

A method includes receiving from a first digital object management system a message requesting a transfer of management responsibilities for a digital object representing an asset from the first digital object management system to a second digital object management system. The method also can include, responsive to receiving the message requesting the transfer of the management responsibilities for the digital object representing the asset from the first digital object management system to the second digital object management system, retrieving the digital object from the first digital object management system, performing at least one operation updating data contained within the digital object by executing, using a first processor, at least a first application contained within the digital object, and communicating the digital object to the second digital object management system for storage in a digital object database.

A system includes at least a first processor programmed to initiate executable operations. The executable operations include receiving from a first digital object management system a message requesting a transfer of management responsibilities for a digital object representing an asset from the first digital object management system to a second digital object management system. The executable operations also can include, responsive to receiving the message requesting the transfer of the management responsibilities for the digital object representing the asset from the first digital object management system to the second digital object management system, retrieving the digital object from the first digital object management system, performing at least one operation updating data contained within the digital object by executing at least a first application contained within the digital object, and communicating the digital object to the second digital object management system for storage in a digital object database.

A computer program includes a computer readable storage medium having program code stored thereon. The program code is executable by at least a first processor to perform a method. The method includes receiving, by the first processor, from a first digital object management system a message requesting a transfer of management responsibilities for a digital object representing an asset from the first digital object management system to a second digital object management system. The method also can include, responsive to receiving the message requesting the transfer of the management responsibilities for the digital object representing the asset from the first digital object management system to the second digital object management system, retrieving, by the first processor, the digital object from the first digital object management system, performing at least one operation updating data contained within the digital object by executing, by the first processor, at least a first application contained within the digital object, and communicating, by the first processor, the digital object to the second digital object management system for storage in a digital object database.

### BRIEF DESCRIPTION OF THE DRAWINGS

FIG. 1 is a block diagram illustrating an example of a network computing environment.

FIG. 2 is a block diagram illustrating an example of a digital object.

FIG. 3 is a flow chart illustrating an example of a method of creating a digital object.

FIG. 4 is a flow chart illustrating an example of a method of accessing data from a digital object.

FIG. 5 is a flow chart illustrating an example of a method of updating data stored within a digital object.

FIG. 6 is a flow chart illustrating an example of a method of transferring a digital object from one digital object management system to another.

FIG. 7 is a flow chart illustrating an example of a method of updating one or more applications contained in a digital object.

FIG. 8 is a block diagram illustrating example architecture for a digital object regulatory system.

FIG. 9 is a block diagram illustrating example architecture for a digital object management system.

### DETAILED DESCRIPTION

This disclosure relates to data processing, and more specifically, to data storage. In accordance with the inventive arrangements disclosed herein, digital objects can be created to represent assets and, more particularly, ownership of assets. The digital objects can be owned by one or more entities that own the respective assets. An asset can be a real asset, a medical profile, or any other type of asset. Examples of a real asset include, but are not limited to, a vehicle, a watercraft, a house, a building, and a parcel of land. Each digital object can contain data and one or more applications configured to maintain the data.

The digital objects are transferrable. For example, when an entity sells a real asset, that entity can transfer ownership of the digital object representing that asset to the entity to which the real asset is sold. Accordingly, the use of digital objects can simplify record keeping for such transactions. Moreover, owners of the digital objects can transfer management of the digital objects to digital object management systems of their choice. For example, an owner of various assets may choose to store their digital objects for those assets in a digital object management system of his/her bank. If the owner changes banks, the owner can transfer management of the digital objects to the new bank.

Further, data can be added to the digital objects to reflect various circumstances. For example, if a digital object represents a vehicle, maintenance and repair records for the vehicle can be stored in the digital object. Accordingly, if the owner of the vehicle chooses to sell the vehicle, the maintenance and repair records can be accessed from the digital object. In another example, if the digital object represents a medical profile of the person, medical records for the person can be stored in the digital object. Thus, the medical records can be accessed from the digital object for review by the person, physicians, etc.

Several definitions that apply throughout this document now will be presented.

As defined herein, the term “digital object” means a functional data structure representing an asset, the functional data structure including program code configured to perform executable operations on data associated with the asset.

As defined herein, the term “real asset digital object” means a digital object representing ownership of a particular real asset by at least one entity, wherein the data associated with the asset at least includes identification information for the real asset and identification information for the at least one entity that owns the real asset.

As defined herein, the term “real asset” means physical object owned by at least one entity.

As defined herein, the term “medical digital object” means a digital object representing a medical profile of a person, wherein the data associated with the asset at least includes medical records of the person and identification information for the person. In this regard, the asset represented by a “medical digital object” is the medical profile of the person.

As defined herein, the term “digital object regulatory system” means system comprising at least one processor and memory that regulates transfers of digital objects between digital object management systems. In addition to regulating transfers of digital objects, a “digital object regulatory system” may also regulate creation of digital objects.

As defined herein, the term “digital object management system” means a system comprising at least one processor and memory that manages storage of digital objects for owners of the digital objects.

As defined herein, the term “client device” means a processing system including at least one processor and memory that requests shared services from a server, and with which a user directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. Network infrastructure, such as routers, firewalls, switches, access points and the like, are not client devices as the term “client device” is defined herein.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “computer readable storage medium” means a storage medium that contains or stores program code for use by or in connection with an instruction execution system, apparatus, or device. As defined herein, a “computer readable storage medium” is not a transitory, propagating signal per se.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real time” means a level of processing responsiveness that a user or system senses as sufficiently immediate for a particular process or determination to be made, or that enables the processor to keep up with some external process.

As defined herein, the term “automatically” means without user intervention.

As defined herein, the term “user” means a person (i.e., a human being).

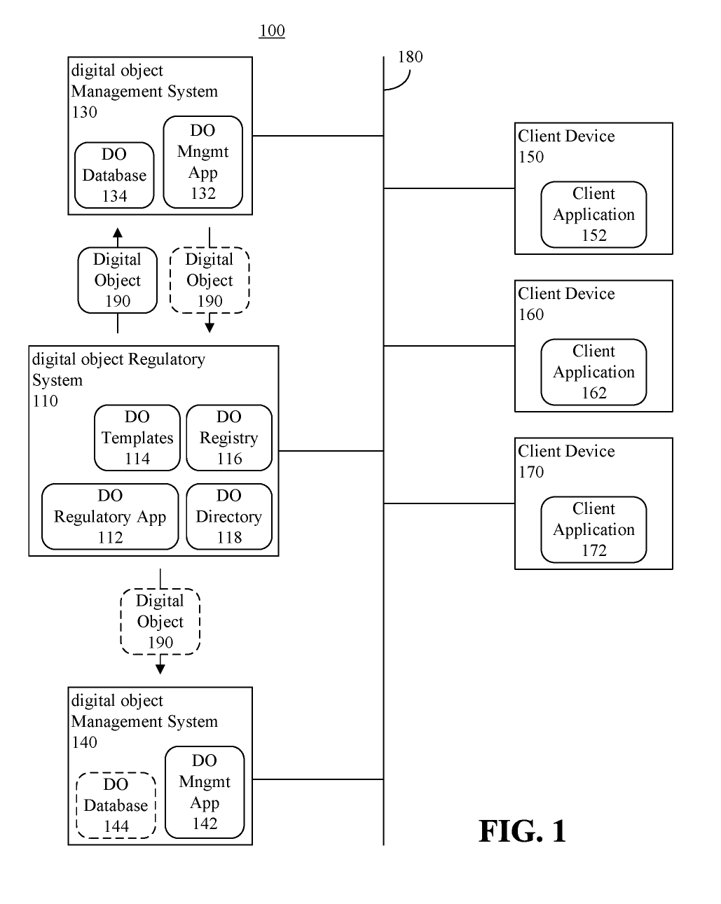

FIG. 1 is a block diagram illustrating an example of a network computing environment 100. The network computing environment 100 can include a digital object regulatory system (hereinafter “regulatory system”) 110, a plurality of digital object management systems (hereinafter “management systems”) 130, 140, and a plurality of client devices 150, 160, 170. The regulatory system 110, the plurality of management systems 130, 140 and the plurality of client devices 150-170 can be communicatively linked via at least one communication network 180. The communication network 180 is the medium used to provide communications links between various devices and data processing systems connected together within the network computing environment 100. The communication network 180 may include connections, such as wire, wireless communication links, or fiber optic cables. The communication network 180 can be implemented as, or include, any of a variety of different communication technologies such as a WAN, a LAN, a wireless network, a mobile network, a Virtual Private Network (VPN), the Internet, the Public Switched Telephone Network (PSTN), or similar technologies. In one arrangement, the plurality of management systems 130, 140 can link to the regulatory system 110 via one or more VPNs or one or more other type of secured communication links.

The regulatory system (hereinafter “regulatory system”) 110 can host a digital object regulatory application (hereinafter “regulatory application”) 112. The regulatory application 112 can be configured to regulate creation of digital objects, for example a digital object 190. In one arrangement, the regulatory application 112 can be configured to create the digital objects. For example, the regulatory system 110 can include digital object templates (hereinafter “templates”) 114. The regulatory application 112 can create digital objects using the templates 114, as will be described. In another arrangement, the regulatory application 112 can interface with another application (not shown) which creates the digital objects at the behest of the regulatory application 112. For simplicity, the following examples describe the regulatory application 112 creating the digital object 190, though the present arrangements are not limited in this regard.

The regulatory application 112 also can register digital objects in a digital object registry 116 (e.g., a digital object registry database), and store links, for example uniform resource identifiers (URIs) or uniform resource locators (URLs), to digital objects in a digital object directory 118. The regulatory application 112 also can regulate the transfer of digital objects between management systems, for example the managements systems 130, 140. Further, the regulatory application 112 can regulate updates to applications contained in the digital objects.

Each of the management systems 130, 140 can include a respective digital object management application (hereinafter “management application”) 132, 142 and a respective digital object database 134, 144. The management applications 132, 142 can store digital objects in the respective digital object databases (hereinafter “databases”) 134, 144. In one arrangement, the regulatory application 112 can interface with the management applications 132, 142 to ensure that any particular digital object, for example the digital object 190, is not stored in more than one digital object database 134, 144 at any moment in time. The management applications 132, 142 also can update applications contained in digital objects at the behest of the regulatory application 112. Further, the management applications 132, 142 can update data contained in digital objects, as will be described. For example, the management applications 132, 142 can include, or otherwise access, application programming interfaces (APIs) configured to access digital object applications to perform updates on digital object data.

Each of the client devices 150, 160, 170 can include respective client applications 152, 162, 172 configured to interface with the regulatory application 112 and/or management applications 132, 142. The client applications 152-172 can be, for example, web browsers, mobile applications, or other applications specifically configured to interface with the regulatory application 112 and/or management applications 132, 142.

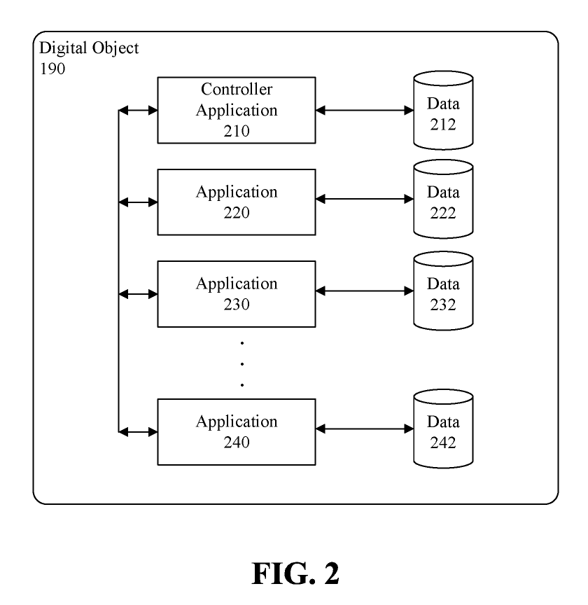

FIG. 2 is a block diagram illustrating an example of a digital object, for example the digital object 190. The digital object 190 can include a controller application 210 and a plurality of applications 220, 230, 240. The digital object also can include a plurality of data tables 212, 222, 232, 242.

The controller application 210 can store to the data table 212 data pertaining to the digital object 190, for example a unique identifier assigned to the digital object 190, a status indicator for the digital object 190, and so on. The status indicator can indicate, for instance, a hold status while the digital object 190 is stored to a digital object database 134, 144 (FIG. 1). Responsive to one or more of the applications 220-240 being initiated to execute by a management application 132, 142 or the regulatory application 112, the controller application 210 can change the status indicator to an active status. In this regard, the controller application 210 can monitor initiation and/or execution of the applications 220-240 and update the status indicator responsive to one or more of the applications are initiated and/or executed. Responsive the application(s) 220-240 completing execution, the controller application 210 can change the status indicator back to indicate a hold status.

Further, the controller application 210 can store to the data table 212 security metadata used to secure data stored in the data tables 222-242. The security metadata can include, for example, one or more security keys used to encrypt and decrypt the data. The controller application 210 can prevent access to the security metadata responsive to the status indicator indicating a hold status. Responsive to the status indicator indicating active status, the controller application 210 can make the security metadata available to the applications 220-240 to encrypt and decrypt the data stored in the data tables 222-242. Accordingly, the data stored in the data tables 222-242 may only be accessible using the respective applications 220-240.

Each application 220, 230, 240 can manage data in a respective data table 222, 232, 242. For example, each application 220, 230, 240 can store data to, update data stored within, and delete data from, a respective data table 222, 232, 242, as will be described. In this regard, each application 220-240 can be configured to store, update and delete a particular type of data. For example, the application 220 can be configured to store and update information about one or more owners of the digital object 190 stored in the data table 222, the application 230 can be configured to store and update information about an asset represented by the digital object 190 stored in the data table 232, the application 240 can be configured to store and update records for the asset (e.g., maintenance records, medical records, etc.) stored in the data table 242, and so on. Each application 220-240 can include an API listener configured to receive calls from APIs to add, update and/or delete data, and add, update and/or delete data in the respective data tables 222-242 accordingly. Further, the API listeners can be configured receive calls from APIs to access the data stored in the data tables, and the applications 220-240 can respond to such calls by providing the requested data.

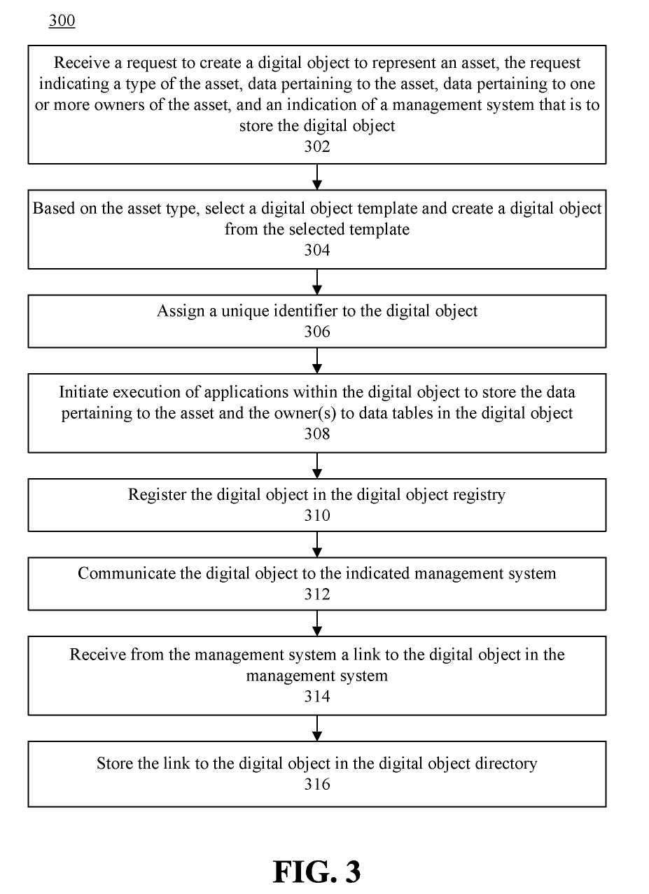

FIG. 3 is a flow chart illustrating an example of a method 300 of creating a digital object 190. In the following description, reference will be made to FIGS. 1-3.

At step 302, the regulatory application 112 can receive from a client device 150 a request to create the digital object 190 to represent an asset. The request also can indicate a type of the asset, data pertaining to the asset, data pertaining to one or more owners of the asset, and an indication of a management system that is to store the digital object 190. The asset can be a real asset, for example a vehicle, a watercraft, a house, a building, and a parcel of land, etc., a medical profile of a person, or any other type of asset.

In illustration, assume that the asset is a newly manufactured vehicle, a representative of the vehicle manufacturer can, using the client application 152, communicate the request to the regulatory application 112. For instance, the representative can use an application (not shown) to automatically generate the data indicating the asset is a vehicle (or type of vehicle), data pertaining to the vehicle (e.g., vehicle identification number (VIN), make, model, color, etc.) and data pertaining to the manufacturer (current owner), and communicate that data to the regulatory application 112. In another arrangement, the data can be communicated to a representative of the regulatory agency managing the regulatory system 110, and that representative can input the data into the regulatory system 110.

In another example, assume the asset is a medical profile. In such case, the request can include data pertaining to a person to whom the medical profile pertains, and data from the person's medical records. A person using the client application 152 can communicate the he request to the regulatory application 112 or a representative of the regulatory agency managing the regulatory system 110, as previously described.

At step 304, based on the type of asset, the regulatory application 112 can select a digital object template 114 for that type of asset and create a digital object 190 from the selected template. The digital object template 114 that is selected can include applications 220-240 specifically configured to manage data for that type of asset. In the case that the asset is a real asset, the digital object 190 can be a real asset digital object. In the case that the asset is a medical profile, the digital object 190 can be a medical digital object.

At step 306, the regulatory application 112 can assign to the digital object 190 a unique identifier. In an arrangement in which the asset to which the digital object 190 is assigned is a real asset, the unique identifier can be a unique identifier for the asset, for example a VIN. In an arrangement in which the asset to which the digital object is assigned is a medical asset, the unique identifier can be a social security number of the person to whom the medical asset is assigned. Further, the regulatory application 112 can communicate to the digital object 190 metadata (e.g., one or more security keys) to be used to encrypt and decrypt data in the data tables 222-242. In one arrangement, the regulatory application 112 can assign to the digital object 190 at least one pass code or password required to access data stored in the digital object 190. For example, the regulatory application 112 can assign to the digital object 190 a pass code or password required to access data from the data tables 222-242 of the digital object 190, a pass code or password required to update the data, a pass code or password required to transfer ownership of the asset represented by digital object 190, and thus the digital object 190, from one entity to another, and so on. In one arrangement, the owner of the asset/digital object 190 can change the pass code/password if desired. The controller application 210 can store the unique identifier, metadata and pass code(s) or password(s) to the data table 212.

At step 308, the regulatory application 112 can initiate execution of applications 220-240 within the digital object 190 to store the data pertaining to the asset and the owner(s) to the data tables 222-242 in the digital object 190. For example, the regulatory application 112 can access APIs for each respective type of data, and communicate the respective types of data to the respective APIs. The APIs can communicate calls to respective API listeners in the applications 220-240. In response, the API listeners can pass the data to the respective applications 220-240, and the applications 220-240 can store the data in the respective data tables 222-242. For example, the applications 220-240 can request from the controller application 210 the security metadata stored in the data table 212, and use the security metadata to encrypt the data stored to the data tables 222-242.

At step 310, the regulatory application 112 can register the digital object 190 in the digital object registry 116. For example, the regulatory application 112 can store the unique identifier assigned to the digital object 190 in the digital object registry 116. The regulatory application 112 also can store in the digital object registry 116 data indicating the management system that is to store the digital object 190. The regulatory application 112 also can store other data in the digital object registry 116, for example a user identifier for a person who provided the request to create the digital object 190, one or more initial owners of the asset, a time/date stamp indicating when the digital object 190 is created, and so on. The regulatory application 112 also can store data indicating the applications 210-240 contained in the digital object 190, and the versions of those applications 210-240.

At step 312, the regulatory application 112 can communicate the digital object 190 to the indicated management system 130, for example over a secured communication link (e.g., a VPN). In response to receiving the digital object 190, the management application 132 can store the digital object 190 to the digital object database 134. Further, the management application 132 can assign a link (e.g., URI or URL) to the digital object 190 in the digital object database 134. Optionally, the management application 132 can add information pertaining to the digital object 190 in a local registry (not shown). In one arrangement, the regulatory application 112 can communicate to the management system 130 at least a portion the data pertaining to the digital object stored in the digital object registry 116, and the management application 132 can store at that data in the local registry.

At step 314, the regulatory application 112 can receive from the management application 132 the link to the digital object 190 in the digital object database 134. At step 316, the regulatory application 112 can store the link in the digital object directory 118, for example in a record assigned to the digital object 190.

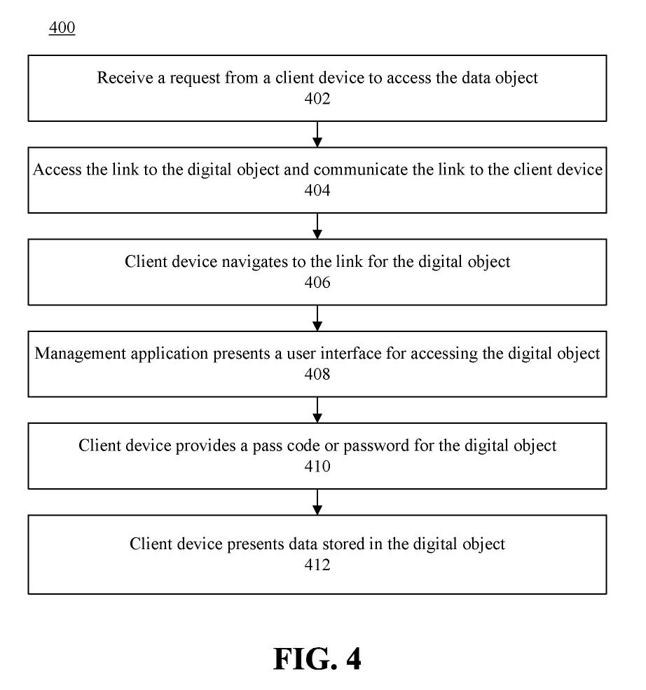

FIG. 4 is a flow chart illustrating an example of a method 400 of accessing data from a digital object 190. In the following description, reference will be made to FIGS. 1, 2 and 4.

At step 402, the regulatory application 112 can receive a request from the client device 160 to access the digital object 190. For example, the client application 162 can communicate the request to the regulatory application 112 at the behest of a user of the client device 160.

At step 404, the regulatory application 112 can access the link to the digital object 190 from the digital object directory 118, and communicate that link to the client application 162. At step 406, using the link, the client application 162 can navigate to the link to the digital object 190. At step 408, in response to the client application 162 navigating to the link, the management application 132 can present a user interface for accessing the digital object 190 on the client device 160 (e.g., on a display) via the client application 162,. In the user interface, the management application 132 can present the unique identifier assigned to the digital object 190. The user interface also can prompt the user of the client device 160 to enter the pass code or password assigned to the digital object 190.

At step 410, responsive to the user entering the pass code or password in the user interface, the client device 160 (e.g., the client application 162) can communicate the password or pass code to the management application 132. The management application 132 can interface with the controller application 210, for example using an API, to authenticate the pass code or password. For example, using the API, the management application 132 can communicate a call, including the pass code or password, to the controller application 210. The API listener for the controller application 210 can detect the call and the controller application 210 can process the pass code or password to authenticate the pass code or password. The controller application can generate a response to the call indicating whether the pass code or password successfully validated, and such response can be communicated to the controller application 210.

At step 412, in response to the pass code or password being authenticated, the client device 160 can present data stored in the digital object, for example via the user interface presented in the client application 162. For example, in response to the pass code or password being successfully validated, using APIs, the management application 132 can call the data from the applications 220-240. The applications 220-240 can access the data from the data tables 222-242, decrypt the data using the security metadata, and communicate the data to the management application 132 via the APIs. Responsive to receiving the data from the applications 220-240, the management application 132 can present the data in the user interface. As noted, the client device 160 can present the user interface. In one arrangement, the data that is presented can be data for which access is authorized based on the particular password or pass code that is entered.

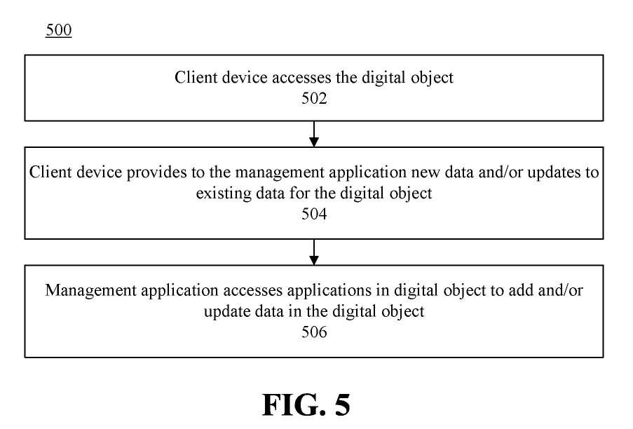

FIG. 5 is a flow chart illustrating an example of a method 500 of updating data stored within a digital object. In the following description, reference will be made to FIGS. 1, 2 and 5.

At step 502, the client device 160 (e.g., a user of the client device 160) can access the digital object 190, for example in accordance with the method 400 of FIG. 4. Via the user interface, the management application 132 can present data contained in the data tables 222-242 of the digital object 190 as previously described.

At step 504, via the user interface, the user of the client device 160 can provide to the management application 132 new data and/or updates to existing data for the digital object 190. By way of example, if the asset represented by the digital object 190 is a vehicle, a user representing a vehicle maintenance facility performing repairs or maintenance on the vehicle can provide data indicating the repairs or maintenance being performed. In another example, if the asset is a medical profile, a physician or assistant can provide data indicating medical information about the person who is the subject of the medical profile.

Whether the user is allowed to add and/or update data, and which data the user may add and/or update, can depend on the pass code or password entered by the user. Assuming, based on the entered pass code or password, the user is allowed to add and/or update the data, at step 506 the management application 132 can initiate the applications 220-240 in the digital object 190 corresponding to the type of data being added and/or updated to add and/or update the data in digital object 190. For example, the management application 132 can use APIs to communicate calls to the applications 220-240. The calls can include the data being added and/or updated. The API listeners in the applications 220-240 can receive the calls for the applications 220-240. The applications 220-240 can add the data to and/or update data within the data tables 222-242 as previously described. As noted, the applications 220-240 can use security metadata to encrypt the data. If the data comprises maintenance, repair or medical records, the applications 220-240 can add the data to the data tables 222-242 as data table records. For example, if the data table 232 contains maintenance records and the application 230 is a maintenance application, the management application 132 can initiate an “AddLog” operation in the application 230 to add new maintenance records to the data table 232.

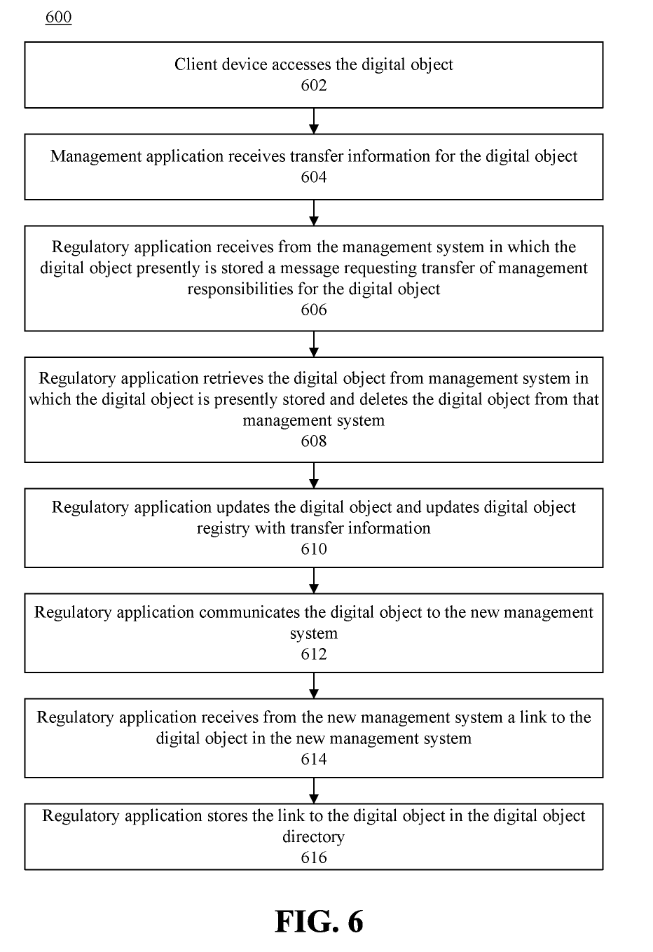

FIG. 6 is a flow chart illustrating an example of a method 600 of transferring a digital object 190 from one digital object management system 130 to another digital object management system 140. In the following description, reference will be made to FIGS. 1, 2 and 6.

The method 600 can be implemented, for example, if ownership of an asset represented by the digital object 190, and thus ownership of the digital object 190, is being changed. In another arrangement, the owner of the digital object 190 may choose to transfer the digital object to another management system 140.

At step 602, the client device 170 (e.g., a user of the client device 170) can access the digital object 190, for example in accordance with the method 400 of FIG. 4. Via the user interface, the management application 132 can present data contained in the data tables 222-242 of the digital object 190 as previously described.

At step 604, the management application 132 in which the digital object 190 currently is stored can receive transfer information for the digital object. In illustration, via the user interface, the management application 132 can present on the client device 170 (e.g., via the client application 172), a menu item selectable by a user of the client device 170 (e.g., the owner of the digital object) to initiate transfer of the digital object. Responsive to the user selecting the menu item, the management application 132 can present fields in which the user enters the transfer information. If the user is transferring the digital object 190 to another management system 140, the user can enter information identifying that management system 140 and one or more pass codes and/or passwords to authenticate the user in order to perform the transfer operation. If the user is transferring ownership of the digital object 190, the user also can enter information for the new owner(s).

At step 606, the regulatory application 112 can receive from the management system 130 in which the digital object 190 presently is stored a message requesting transfer of management responsibilities for the digital object 190. At step 608, responsive to the message, the regulatory application 112 can retrieve the digital object 190 from the management system 130 for example over a secured communication link (e.g., a VPN). In response to retrieving the digital object 190, the regulatory application 112 can delete the digital object 190 from the management system 130 (e.g., delete the digital object 190 from the digital object database 134). In this regard, the regulatory application 112 can maintain access to the digital object database 134. In another arrangement, the regulatory application 112 can communicate a request to the management system 130 to delete the digital object 190 from the digital object database 134, and wait to receive a response confirming the deletion before continuing with further processes.

At step 610, the regulatory application 112 can perform at least one operation updating data contained within the digital object 190. Further, the regulatory application 112 can update the digital object registry 116 with the transfer information. In illustration, the regulatory application 112 use one or more APIs to initiate one or more of the applications 220-240 to update data contained in one or more data tables 222-242, as previously described. For example, if ownership of the digital object 190 is being transferred, and ownership data is contained in the data table 222, the regulatory application 112 can, using an API, communicate a call to the application 220 to update the ownership data. The call can include the new ownership data. Responsive to an API listener in the application 220 detecting the call, the application 220 can update the ownership data in the data table 222 with the new ownership data. For instance, the call can initiate a “setOwner” operation in the application 220 to update the ownership data. Further, the regulatory application 112 can update the digital object registry 116 to indicate the new management system 140, as well as update and/or add any other suitable data, for example a time/date stamp when the request is received, a user identifier for the user initiating the request, etc.

At step 612, the regulatory application can communicate the digital object 190 to the new management system 140, for example over the secured communication link. In response to receiving the digital object 190, the management application 142 can store the digital object 190 to the digital object database 144. Further, the management application 142 can assign a link (e.g., URI or URL) to the digital object 190 in the digital object database 144. Optionally, the management application 142 can add information pertaining to the digital object 190 in a local registry (not shown). In one arrangement, the regulatory application 112 can communicate to the management system 140 at least a portion the data pertaining to the digital object stored in the digital object registry 116, and the management application 142 can store at that data in the local registry.

At step 614, the regulatory application 112 can receive from the management application 142 the link to the digital object 190 in the digital object database 144. At step 616, the regulatory application 112 can store the link in the digital object directory 118, for example in a record assigned to the digital object 190.

At this point it should be noted that by deleting the digital object from the management system 130 (e.g., from the digital object database 134) before communicating the digital object 190 to the management system 140, the regulatory application 112 can ensure that the management system 130 and management system 140 do not simultaneously contain copies of the digital object 190. Thus, the regulatory application 112 can ensure that there is only a single instance of a digital object 190 deployed to management systems for any particular asset.

In one arrangement, the regulatory application 112 can maintain in the digital object registry any data and other information needed to reconstruct the digital object 190 should the digital object 190 ever become corrupted. In such case, the management applications 132, 142 can communicate to the regulatory application 112 updated, added or deleted data each time a digital object 190 is updated, and the regulatory application 112 can store such data in the digital object registry 116. In another arrangement, the regulatory application can maintain an inactive copy of the latest version of the digital object 190. For example, at periodic intervals the regulatory application 112 can perform a backup of the digital object databases 134, 144.

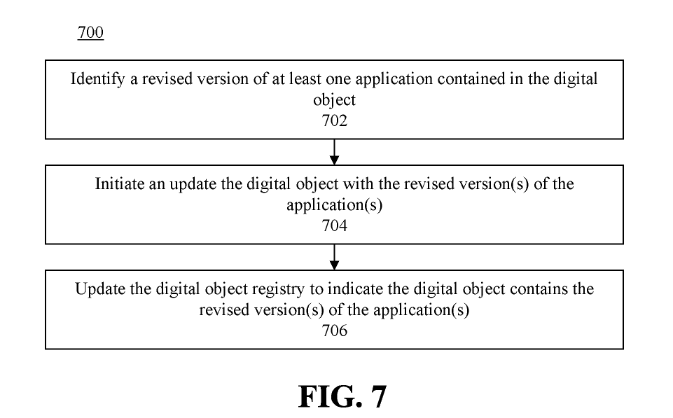

FIG. 7 is a flow chart illustrating an example of a method 700 of updating one or more applications contained in a digital object. In the following description, reference will be made to FIGS. 1, 2 and 7.

At step 702, the regulatory application 112 can identify at least one revised version of at least one application 210-240 contained in the digital object 190. In illustration, the regulatory application 112 can identify at least one revised version of an application used in digital objects of a particular type. The regulatory application 112 can search the digital object registry 116 to identify all digital objects that are that particular type, and identify the links for each of such digital objects.

At step 704, the regulatory application 112 can initiate an update the digital objects of the particular type with the revised version(s) of the application(s). In this example, it is assumed that the digital object 190 matches the particular type. Using the link for the digital object 190, the regulatory application 112 can initiate a call of an “ApplicationUpdate” operation in the controller application 210 to update one or more the application(s) 210-240. In illustration, the regulatory application 112 can communicate a request to the management application 132 on management system 130 in which the digital object 190 is presently stored. The request can indicate the application(s) 210-240 to be updated, and can include the updates for the application(s) 210-240, or links to such updates. The updates can include changes to program code, parameters, application names, etc.

In response to receiving the request, the management application 132 can validate the request. For example, the request can include one or more pass codes, passwords, etc., and the management application 132 can validate such. Further, the management application 132 can validate the regulatory application 112 sending the request, for example based on an IP address of the regulatory system 110 from which the request is sent, or based on any other information that may be used for validation purposes.

Responsive to validating the request and the regulatory application 112, the management application 132 can access the updates and initiate the call to the “ApplicationUpdate” operation in the controller application 210 using an appropriate API. An API listener of the controller application 210 can detect the call and, in response, initiate the “ApplicationUpdate” operation to implement the updates to the application(s) 210-240. In response to the update(s) being completed, the controller application 210 can communicate a response to the management application 132 indicating whether the update(s) were successful. In response, the management application 132 can communicate a response to the request received from the regulatory application 112 indicating the updates were completed.

At step 706, responsive to the response received from the management application 132, the regulatory application 112 can update the digital object registry 116 to indicate the digital object 190 contains the revised version(s) of the application(s).

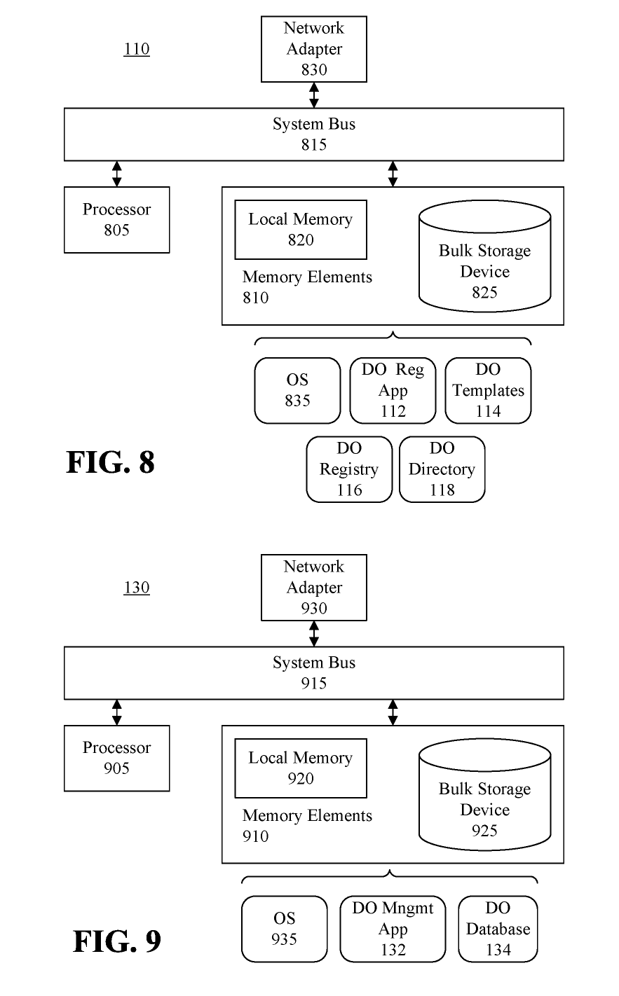

FIG. 8 is a block diagram illustrating example architecture for the digital object regulatory system 110. The digital object regulatory system 110 can include at least one processor 805 (e.g., a central processing unit) coupled to memory elements 810 through a system bus 815 or other suitable circuitry. As such, the digital object regulatory system 110 can store program code within the memory elements 810. The processor 805 can execute the program code accessed from the memory elements 810 via the system bus 815. It should be appreciated that the digital object regulatory system 110 can be implemented in the form of any system including a processor and memory that is capable of performing the functions and/or operations described within this specification. For example, the digital object regulatory system 110 can be implemented as a server, a plurality of communicatively linked servers, or any other suitable processing system(s).

The memory elements 810 can include one or more physical memory devices such as, for example, local memory 820 and one or more bulk storage devices 825. Local memory 820 refers to random access memory (RAM) or other non-persistent memory device(s) generally used during actual execution of the program code. The bulk storage device(s) 825 can be implemented as a hard disk drive (HDD), solid state drive (SSD), or other persistent data storage device. The digital object regulatory system 110 also can include one or more cache memories (not shown) that provide temporary storage of at least some program code in order to reduce the number of times program code must be retrieved from the bulk storage device 825 during execution.

One or more network adapters 830 can be coupled to digital object regulatory system 110 to enable the digital object regulatory system 110 to become coupled to other systems, computer systems, remote printers, and/or remote storage devices through intervening private or public networks. Modems, cable modems, transceivers, and Ethernet cards are examples of different types of network adapters 830 that can be used with the digital object regulatory system 110.

As pictured in FIG. 8, the memory elements 810 can store the components of the digital object regulatory system 110, namely an operating system 835, the digital object regulatory application 112, the digital object templates 114, the digital object registry 116 and the digital object directory 118. Being implemented in the form of executable program code, the operating system 835 and the digital object regulatory application 112 can be executed by the digital object regulatory system 110 and, as such, can be considered part of the digital object regulatory system 110. Moreover, the digital object templates 114, digital object registry 116 and digital object directory 118 are functional data structures that impart functionality when employed as part of the digital object regulatory system 110, and can be considered part of the digital object regulatory system 110.

FIG. 9 is a block diagram illustrating example architecture for the digital object management system 130. The digital object management system 140 can be configured in a similar manner. The digital object management system 130 can include at least one processor 905 coupled to memory elements 910 through a system bus 915 or other suitable circuitry. As such, the digital object management system 130 can store program code within the memory elements 910. The processor 905 can execute the program code accessed from the memory elements 910 via the system bus 915. It should be appreciated that the digital object management system 130 can be implemented in the form of any system including a processor and memory that is capable of performing the functions and/or operations described within this specification. For example, the digital object management system 130 can be implemented as a server, a plurality of communicatively linked servers, or any other suitable processing system(s).

The memory elements 910 can include one or more physical memory devices such as, for example, local memory 920 and one or more bulk storage devices 925. The digital object management system 130 also can include one or more cache memories (not shown) that provide temporary storage of at least some program code in order to reduce the number of times program code must be retrieved from the bulk storage device 925 during execution. One or more network adapters 930 can be coupled to digital object management system 130 to enable the digital object management system 130 to become coupled to other systems, computer systems, remote printers, and/or remote storage devices through intervening private or public networks.

As pictured in FIG. 9, the memory elements 910 can store the components of the digital object management system 130, namely an operating system 935, the digital object management application 132 and the digital object database 134. Being implemented in the form of executable program code, the operating system 935 and the digital object management application 132 can be executed by the digital object management system 130 and, as such, can be considered part of the digital object management system 130. Moreover, the digital object database is a functional data structure that imparts functionality when employed as part of the digital object management system 130, and can be considered part of the digital object management system 130.

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” or similar language means that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving from a first digital object management system a message requesting a transfer of management responsibilities for a digital object representing an asset from the first digital object management system to a second digital object management system;
responsive to receiving the message requesting the transfer of the management responsibilities for the digital object representing the asset from the first digital object management system to the second digital object management system:
retrieving the digital object from the first digital object management system;
performing at least one operation updating data contained within the digital object by executing, using a first processor, at least a first application contained within the digital object; and
communicating the digital object to the second digital object management system for storage in a digital object database.

2. The method of claim 1, further comprising:
ensuring that the first digital object management system and the second digital object management system do not simultaneously contain copies of the digital object by, responsive to retrieving the digital object from the first digital object management system, deleting the digital object from the first digital object management system prior to inserting the digital object into the second digital object management system.

3. The method of claim 1, wherein the digital object is a real asset digital object representing ownership of a real asset by at least a first entity.

4. The method of claim 3, wherein performing at least one operation updating data contained within the digital object comprises:
updating ownership data contained within the real asset digital object to change ownership of the real asset from at least the first entity to at least a second entity by executing the first application contained in the real asset digital object.

5. The method of claim 3, wherein the real asset digital object further contains at least a second application, the second application configured to be executed by the first processor or at least a second processor to perform at least one operation adding at least one maintenance record for the real asset to the real asset digital object.

6. The method of claim 1, wherein the digital object is a medical digital object representing a medical profile of a person, the medical digital object at least including medical records of the person.

7. The method of claim 6, wherein the medical digital object further contains at least a second application, the second application configured to be executed by the first processor or at least a second processor to perform at least one operation adding at least one medical record for the person to the medical digital object.

8. A system, comprising:
at least a first processor programmed to initiate executable operations comprising:
receiving from a first digital object management system a message requesting a transfer of management responsibilities for a digital object representing an asset from the first digital object management system to a second digital object management system;
responsive to receiving the message requesting the transfer of the management responsibilities for the digital object representing the asset from the first digital object management system to the second digital object management system:
retrieving the digital object from the first digital object management system;
performing at least one operation updating data contained within the digital object by executing at least a first application contained within the digital object; and
communicating the digital object to the second digital object management system for storage in a digital object database.

9. The system of claim 8, the executable operations further comprising:
ensuring that the first digital object management system and the second digital object management system do not simultaneously contain copies of the digital object by, responsive to retrieving the digital object from the first digital object management system, deleting the digital object from the first digital object management system prior to inserting the digital object into the second digital object management system.

10. The system of claim 8, wherein the digital object is a real asset digital object representing ownership of a real asset by at least a first entity.

11. The system of claim 10, wherein performing at least one operation updating data contained within the digital object comprises:
updating ownership data contained within the real asset digital object to change ownership of the real asset from at least the first entity to at least a second entity by executing the first application contained in the real asset digital object.

12. The system of claim 10, wherein the real asset digital object further contains at least a second application, the second application configured to be executed by the first processor or at least a second processor to perform at least one operation adding at least one maintenance record for the real asset to the real asset digital object.

13. The system of claim 8, wherein the digital object is a medical digital object representing a medical profile of a person, the medical digital object at least including medical records of the person.

14. The system of claim 13, wherein the medical digital object further contains at least a second application, the second application configured to be executed by the first processor or at least a second processor to perform at least one operation adding at least one medical record for the person to the medical digital object.

15. A computer program product comprising a computer readable storage medium having program code stored thereon, the program code executable by at least a first processor to perform a method comprising:
receiving, by the first processor, from a first digital object management system a message requesting a transfer of management responsibilities for a digital object representing an asset from the first digital object management system to a second digital object management system;
responsive to receiving the message requesting the transfer of the management responsibilities for the digital object representing the asset from the first digital object management system to the second digital object management system:
retrieving, by the first processor, the digital object from the first digital object management system;
performing at least one operation updating data contained within the digital object by executing, using a first processor, at least a first application contained within the digital object; and
communicating, by the first processor, the digital object to the second digital object management system for storage in a digital object database.

16. The computer program product of claim 15, the method further comprising:
ensuring that the first digital object management system and the second digital object management system do not simultaneously contain copies of the digital object by, responsive to retrieving the digital object from the first digital object management system, deleting the digital object from the first digital object management system prior to inserting the digital object into the second digital object management system.

17. The computer program product of claim 15, wherein the digital object is a real asset digital object representing ownership of a real asset by at least a first entity.

18. The computer program product of claim 17, wherein performing at least one operation updating data contained within the digital object comprises:
updating ownership data contained within the real asset digital object to change ownership of the real asset from at least the first entity to at least a second entity by executing the first application contained in the real asset digital object.

19. The computer program product of claim 17, wherein the real asset digital object further contains at least a second application, the second application configured to be executed by the first processor or at least a second processor to perform at least one operation adding at least one maintenance record for the real asset to the real asset digital object.

20. The computer program product of claim 15, wherein the digital object is a medical digital object representing a medical profile of a person, the medical digital object at least including medical records of the person.
